(19) United States
(12) Patent Application Publication
(10) Pub. No.: US 2026/0129055 A1
(43) Pub. Date: May 7, 2026

(54) Adaptive AI Cybersecurity System for Threat Identification, Prevention, and Device Monitoring

(71) Applicant: Alexander Davis, Oxnard, CA (US)

(72) Inventor: Alexander Davis, Oxnard, CA (US)

(21) Appl. No.: 18/935,612

(22) Filed: Nov. 3, 2024

(51) Int. Cl. H04L 9/40

(52) U.S. Cl. CPC H04L 63/1416; H04L 63/1425

(57) ABSTRACT

The present invention relates to an AI-driven cybersecurity system that provides adaptive protection by identifying, mitigating, and preventing cyber threats in real-time. The system leverages advanced machine learning algorithms to detect anomalies in network traffic, enabling the identification of potential threats, which are then neutralized through automatic adjustments to firewall rules and network configurations. The system includes a tracing module capable of locating the source of cyberattacks by analyzing IP addresses and other network metadata, allowing for comprehensive incident reporting. Additionally, the invention logs and monitors all devices connecting to the network, both via Wi-Fi and hardline access, ensuring security compliance and detecting unauthorized activity. The system's adaptive approach ensures continuous protection by automatically updating security measures and reporting detailed findings to security personnel for future prevention.

### BACKGROUND OF THE INVENTION

### Field of Invention

The present invention relates to the field of cybersecurity, specifically to adaptive, AI-driven systems that autonomously detect, mitigate, and prevent cyber threats. The invention utilizes machine learning algorithms to identify security vulnerabilities, respond in real-time by adapting and patching potential entry points, and track the origins of cyber threats by tracing IP addresses. Additionally, the system generates detailed reports documenting each threat and the applied solutions, ensuring ongoing improvement in threat prevention.

The invention also includes a comprehensive security measure that logs and monitors all devices accessing a network, whether via Wi-Fi or hardline, providing robust, real-time device access management. This is particularly critical for securing physical network connections, which often receive less oversight than wireless networks. The invention's approach provides a holistic, adaptive, and traceable cybersecurity solution for protecting digital infrastructures from emerging and persistent threats.

### BRIEF SUMMARY OF THE INVENTION

The present invention provides an advanced AI-driven cybersecurity system designed to detect, adapt to, and mitigate cyber threats in real-time. By employing machine learning, the system identifies vulnerabilities and proactively adjusts network defenses, preventing future attacks. It traces the origins of threats, such as IP addresses, and generates comprehensive incident reports, documenting how each threat was managed and how similar risks will be addressed moving forward. Additionally, the invention includes a robust monitoring tool that logs all devices accessing a network via Wi-Fi or hardline, ensuring complete oversight and increased security of both wireless and wired network access points. This integrated approach enhances protection by dynamically responding to threats while providing traceable, actionable data for continuous improvement.

### BRIEF DESCRIPTION OF THE FIGURES

FIG. 1:7-step collaborative process where the AI detects and blocks threats, generates reports for human review, adapts from human feedback, and continuously improves threat detection and mitigation through an ongoing learning cycle.

### DETAILED DESCRIPTION

The present invention is an AI-driven cybersecurity system that revolutionizes the way digital environments are protected against emerging threats. This section offers a detailed description of the invention by breaking down its various components, functionalities, and operational methods, providing an in-depth understanding of who benefits from it, what it accomplishes, how it works, and why it is necessary. This AI cybersecurity system is intended for a wide range of users across various industries. Primary beneficiaries include:
Corporations: Enterprises dealing with sensitive information, such as finance, healthcare, or defense, are key users. These organizations need robust security measures to protect their data against cyberattacks, phishing schemes, malware, and more.
Small-to-Medium Enterprises (SMEs): As smaller entities increasingly face the same cyber threats as larger organizations, they also require a scalable, adaptive cybersecurity solution.
Government Agencies: With their sensitive data at constant risk of espionage, governmental bodies can utilize the AI's ability to dynamically respond to sophisticated threats.
Home Users and IoT Environments: As smart homes and IoT devices proliferate, individuals face cyber risks. This invention addresses these challenges by ensuring security for all devices accessing home networks, either through Wi-Fi or hardwired connections.
Cybersecurity Professionals: The system also serves cybersecurity experts, providing them with detailed reports and insights into cyber incidents to help improve future defenses.

The system provides comprehensive protection against known and unknown cybersecurity threats by:
Identifying Threats: The system continuously scans and monitors network traffic to detect suspicious activity and potential vulnerabilities, using machine learning algorithms to identify evolving threats like malware, ransomware, and phishing attempts.
Adapting to Threats: Upon detecting a threat, the system dynamically adjusts its security parameters to close any vulnerabilities in the network. The AI-powered system learns from each interaction, creating more robust defenses over time.
Tracing the Origin of Threats: Once a cyber threat is detected, the system traces its origin by analyzing network packets, tracking IP addresses, and identifying the geographic and virtual origin of the attack.
Generating Incident Reports: For every security incident, the system generates a detailed report. This includes an overview of the threat, how it entered the system, the actions taken to mitigate the risk, and recommendations for preventing future attacks.
Logging and Monitoring Devices: In an age where network security encompasses more than just internet-facing devices, the system logs every device that accesses the network, whether through Wi-Fi or hardline connections. This guarantees complete oversight of all network activity.

The AI cybersecurity system can be deployed in various digital environments, including:
Corporate Networks: Enterprises with vast networks and diverse data sources benefit from the system's capacity to monitor and secure internal networks and external data pipelines.
Cloud Environments: Cloud-based infrastructure, which is vulnerable to cyberattacks due to its open accessibility, can be secured using this system to ensure secure connections between users and cloud resources.
Industrial Control Systems (ICS): In industries like energy, manufacturing, and utilities, this system can protect critical infrastructures, including SCADA systems, from cyberattacks targeting operational technologies.
Residential Networks: In homes with growing numbers of IoT devices, such as smart thermostats, refrigerators, and cameras, this invention protects against cyber intrusion while ensuring smooth device communication.

The system operates continuously and autonomously, offering real-time protection without the need for manual intervention. Its ability to dynamically learn and adapt from previous incidents ensures that it is always one step ahead of evolving cyber threats. However, it can also be configured to perform scheduled tasks, such as routine scans or penetration testing, at predefined intervals.

The invention addresses several critical issues in modern cybersecurity:
Increasing Sophistication of Cyber Threats: Cyberattacks are growing in complexity, often bypassing traditional firewall and antivirus solutions. The need for a dynamic, intelligent system that can adapt to new threats in real-time is essential to protect against modern attacks.
Limitations of Existing Security Solutions: Many existing cybersecurity systems focus on predefined rules and known threats, leaving networks vulnerable to zero-day attacks and unknown vulnerabilities. This system uses AI and machine learning to recognize and respond to previously unidentified threats.
Increased Network Complexity: As organizations move towards cloud-based operations and remote work, traditional cybersecurity measures often fail to secure distributed networks. The invention's ability to monitor and protect all devices, both wireless and hardwired, ensures comprehensive protection.
Data Breach Prevention: By detecting and responding to vulnerabilities immediately, the system minimizes the risk of data breaches that could result in financial losses, legal penalties, or damage to a company's reputation.

The AI cybersecurity system comprises several interrelated components that work in harmony to detect, address, and prevent security breaches. The primary operational flow is as follows:
Threat Identification: The system constantly monitors network traffic, analyzing data packets for signs of anomalous or malicious behavior. Leveraging AI algorithms, it can identify both known and emerging threats by detecting abnormal patterns, even in encrypted traffic.
Adaptation: Once a threat is identified, the system takes immediate action. This can include updating firewall rules, isolating vulnerable systems, or even temporarily halting network services to prevent the spread of malware. The AI-driven system also learns from each incident, adapting its behavior to better protect against similar threats in the future.
Threat Tracing: The system's advanced tracing functionality allows it to follow the data trail back to the source of the attack. By identifying the IP address and geographic location, cybersecurity teams can take proactive measures to block similar threats.
Incident Reporting: After neutralizing the threat, the system generates a detailed incident report. This report includes:

An overview of the threat
How the threat was detected
Actions taken to mitigate the issue
Potential vulnerabilities that need to be addressed
Recommendations for improving security measures
Device Monitoring: In addition to monitoring internet-facing devices, the system logs every device that connects to the network, whether via Wi-Fi or hardline access. This is particularly important for environments where physical access to the network, such as plugging in an Ethernet cable, could create a vulnerability.
AI Learning and Improvements: As the system continues to monitor and address threats, it leverages machine learning to refine its detection algorithms, making it more accurate and responsive to future attacks. Each incident informs future decision-making, and the AI learns to recognize subtle patterns that may indicate a cyberattack.
Prevention and Hardening: The system not only responds to threats but also proactively strengthens network defenses. By identifying weak points in the infrastructure and automatically adjusting network settings, the system helps prevent future attacks. This includes patching vulnerabilities and setting up advanced defense mechanisms for high-risk areas.

### Features of the System:

Customizable Defense Mechanisms: Users have the flexibility to customize the system's defense strategies, enabling or disabling specific features based on their unique security needs. This flexibility ensures that the system can be tailored to different industries or environments.
Scalable Architecture: The system is designed to grow with the user's needs. Whether it's a small business or a large multinational organization, the system can scale its operations to protect networks of any size.
Data Privacy Compliance: The system is compliant with global data privacy regulations, such as GDPR and CCPA. It ensures that data collection and monitoring are done securely, without violating user privacy.
Seamless Integration with Existing Systems: The invention integrates seamlessly with existing security infrastructure, including antivirus software, firewalls, and intrusion detection systems, making it seamless without requiring overhauls of pre-existing cybersecurity systems. By providing a comprehensive, adaptive, and real-time defense against a variety of cyber threats, the invention revolutionizes how organizations and individuals safeguard their networks and data.

```
  import time
  import logging
  import random
  import socket
  from datetime import datetime
  # Setting up logging for report generation and monitoring
  logging.basicConfig(filename=“cyber_security_log.txt”,
level=logging.INFO)
  class AICyberSecuritySystem:
    def _{——}init_{——}(self):
      self.devices_logged = { } # Dictionary to log all devices
accessing network
      self.threats_detected = [ ] # Store details of detected threats
      self.ip_tracing_log = [ ] # Store traced IPs
      self.incident_reports = [ ] # Store incident reports
      self.network_activity_log = [ ] # Simulating network activity
      self.firewall_rules = [“ALLOW:80”, “ALLOW:443”, “DENY:23”] #
Default firewall rules
      self.logged_devices_report = [ ] # Device logging reports
    def monitor_network(self):
      “““ Simulated method to monitor network traffic and detect
threats. ”””
      print(“Monitoring network for threats...”)
      while True:
        simulated_activity = random.choice([“NORMAL”,
“THREAT_LOW”, “THREAT_MEDIUM”, “THREAT_HIGH”])
        device_id = f“Device-{random.randint(1, 100)}”
        if simulated_activity.startswith(“THREAT”):
          threat = self.identify_threat(device_id, simulated_activity)
          self.threats_detected.append(threat)
          self.adapt_firewall_rules(threat)
          self.generate_report(threat)
          self.trace_ip(threat[‘ip_address’])
        self.log_device_activity(device_id)
        time.sleep(3) # Simulated delay in network traffic monitoring
    def identify_threat(self, device, threat_level):
      “““ Identify the threat based on the simulated threat level and
generate corresponding details. ”””
      threat_types = {
        “THREAT_LOW”: [“Phishing Attempt”, “Adware”],
        “THREAT_MEDIUM”: [“DDoS Attack”, “SQL Injection”],
        “THREAT_HIGH”: [“Ransomware”, “Malware Infection”]
      }
      ip_address = self.get_random_ip( )
      threat_type = random.choice(threat_types[threat_level])
      timestamp = datetime.now( ).strftime(‘%Y-%m-%d %H:%M:%S’)
      print(f“[ALERT] Threat detected from {device} - Type:
{threat_type}, IP: {ip_address}, Threat Level: {threat_level}”)
      return {
        “device”: device,
        “ip_address”: ip_address,
        “threat_type”: threat_type,
        “threat_level”: threat_level,
        “timestamp”: timestamp
      }
    def adapt_firewall_rules(self, threat):
      “““ Adjust firewall rules dynamically based on threat detection.
”””
      rule = f“DENY:{threat[‘ip_address’]}”
      if rule not in self.firewall_rules:
        self.firewall_rules.append(rule)
        print(f“Firewall rule updated: {rule}”)
        logging.info(f“New firewall rule added: {rule}”)
    def trace_ip(self, ip_address):
      “““ Trace the origin of the threat by resolving the IP address. ”””
      try:
        domain, _, _ = socket.gethostbyaddr(ip_address)
        self.ip_tracing_log.append({“ip”: ip_address, “domain”:
domain})
        print(f“IP traced: {ip_address} -> Domain: {domain}”)
        logging.info(f“Traced IP {ip_address} to Domain: {domain}”)
      except Exception:
        print(f“Failed to trace IP: {ip_address}”)
        logging.error(f“Failed to trace IP: {ip_address}”)
    def log_device_activity(self, device):
      “““ Log each device's activity on the network. ”””
      if device not in self.devices_logged:
        self.devices_logged[device] = {“first_logged”: datetime.now( ),
“activity”: [ ]}
      self.devices_logged[device][“activity”].append(f“Active at
{datetime.now( ).strftime(‘%Y-%m-%d %H:%M:%S’)}”)
      print(f“Device {device} activity logged.”)
      logging.info(f“Device {device} activity logged at
{datetime.now( )}.”)
    def generate_report(self, threat):
      “““ Generate a detailed report for each detected threat. ”””
      report = f“““
      ==== Threat Report ====
      Time: {threat[‘timestamp’]}
      Device: {threat[‘device’]}
      IP Address: {threat[‘ip_address’]}
      Threat Type: {threat[‘threat_type’]}
      Threat Level: {threat[‘threat_level’]}
      Action Taken: Firewall updated, blocking IP:
{threat[‘ip_address’]}
      =======================
      ”””
      self.incident_reports.append(report)
      print(report)
      logging.info(report)
    def get_random_ip(self):
      “““ Generate a random IP address to simulate threats. ”””
      return f“{random.randint(1, 255)}.{random.randint(1,
255)}.{random.randint(1, 255)}.{random.randint(1, 255)}”
    def log_hardline_device(self, mac_address, ip_address,
device_type=“Hardline”):
      “““ Log devices connected via hardline access, typically less
monitored. ”””
      if mac_address not in self.devices_logged:
        self.devices_logged[mac_address] = {
          “device_type”: device_type,
          “ip_address”: ip_address,
          “logged_at”: datetime.now( ).strftime(‘%Y-%m-%d
%H:%M:%S’)
        }
        print(f“{device_type} device logged: MAC Address:
{mac_address}, IP: {ip_address}”)
        logging.info(f“{device_type} device logged: MAC Address:
{mac_address}, IP: {ip_address}”)
      else:
        print(f“Device {mac_address} already logged.”)
    def generate_device_report(self):
      “““ Generate a report for all devices logged into the network,
both Wi-Fi and hardline. ”””
      report = “\n==== Devices Logged Into Network ====\n”
      for device, info in self.devices_logged.items( ):
        report += f“Device: {device}, Type: {info.get(‘device_type’,
‘Wi-Fi’)}, IP: {info.get(‘ip_address’, ‘N/A’)}, Logged At: {info.get(‘logged_at’,
‘N/A’)}\n”
      self.logged_devices_report.append(report)
      print(report)
      logging.info(report)
  # Simulating execution
  if _{——}name_{——} == “_{——}main_{——}”:
    security_system = AICyberSecuritySystem( )
    try:
      # Simulate monitoring network traffic and logging devices
security_system.log_hardline_device(mac_address=“00:1B:44:11:3A:B7”,
ip_address=“192.168.1.2”)
security_system.log_hardline_device(mac_address=“00:1B:44:11:3A:C9”
, ip_address=“192.168.1.3”)
      security_system.monitor_network( )
    except KeyboardInterrupt:
      print(“Monitoring interrupted by user.”)
```

### Key Enhancements:

### Multi-Level Threat Detection:

The system now identifies low, medium, and high-threat levels (e.g., Phishing, DDOS, Ransomware).

Different threats can trigger different firewall actions and logging procedures.

### Firewall Adaptation:

Dynamically updates the firewall rules in response to detected threats.

Each IP associated with a threat gets blocked.

### IP Address Tracing:

Includes a simulated IP tracing feature that maps the IP to a domain.

Logs failures in tracing for future analysis.

### Hardline Device Logging:

Adds functionality to log devices that connect via hardline access (e.g., Ethernet), usually less monitored.

Monitors all types of devices, whether connecting through Wi-Fi or a physical connection.

### Incident Reporting:

Creates detailed reports for each incident detected, which include timestamps, device details, threat levels, and firewall actions taken.

The reports are stored in a log file for further review.

### Device Logging Report:

Generates a detailed list of all devices (hardline or Wi-Fi) accessing the network, including timestamps and IP addresses.

### Network Monitoring Simulation:

Simulates the system's network activity and threat detection process in real-time with periodic logging.

```
  import numpy as np
  from sklearn.ensemble import RandomForestClassifier
  from sklearn.model_selection import train_test_split
  import time
  import random
  class AICyberSecurityThreatDetection:
    def _{——}init_{——}(self):
      self.model = None
      self.network_data = [ ] # Placeholder for network traffic data
    def simulate_real_time_traffic(self):
      “““Simulates real-time network traffic with random features.”””
      # Generating random traffic data (0: Normal, 1: Threat)
      return [random.randint(0, 100), random.uniform(0, 10),
random.randint(0, 1)]
    def load_training_data(self):
      “““Simulates a dataset load for training the ML model.”””
      # Simulating network traffic data (features: [packet_size,
duration, threat])
      data = np.array([[100, 2.5, 1], [200, 5.0, 0], [50, 1.2, 1], [300,
7.0, 0], [120, 2.0, 1]])
      X = data[:, :−1] # Features
      y = data[:, −1] # Labels (0: Normal, 1: Threat)
      return X, y
    def train_model(self):
      “““Train a machine learning model for threat detection.”””
      X, y = self.load_training_data( )
      X_train, X_test, y_train, y_test = train_test_split(X, y,
test_size=0.2, random_state=42)
      # Initialize and train the RandomForest Classifier
      self.model = RandomForestClassifier(n_estimators=100,
random_state=42)
      self.model.fit(X_train, y_train)
      print(“Model trained for real-time threat detection.”)
    def detect_threat(self, real_time_data):
      “““Detect threats in real-time traffic.”””
      if not self.model:
        print(“Model not trained.”)
        return
      # Predict if the traffic is normal or a threat
      prediction = self.model.predict([real_time_data])
      # 0 = Normal, 1 = Threat
      if prediction == 1:
        print(f“Threat detected: {real_time_data}. Taking defensive
actions.”)
        self.prevent_threat(real_time_data)
      else:
        print(f“Normal traffic: {real_time_data}”)
    def prevent_threat(self, threat_data):
      “““Adapt and prevent the threat based on detected
vulnerabilities.”””
      print(f“Analyzing detected threat data: {threat_data}”)
      # Simulate plugging security holes by adapting to the threat
type
      # For example, update firewall rules or tighten access control
      print(f“Plugging security holes for traffic: {threat_data}”)
      self.block_ip(threat_data)
    def block_ip(self, threat_data):
      “““Block the source of the threat by blocking the IP address.”””
      # Simulated IP blocking based on detected threat
      print(f“Blocking IP address associated with threat data:
{threat_data}”)
    def predict_future_threats(self):
      “““Predict future threats based on historical data.”””
      print(“Predicting future vulnerabilities...”)
      # Simulate threat prediction with probabilistic measures
(randomized for now)
      future_threat_likelihood = random.uniform(0, 1)
      if future_threat_likelihood > 0.7:
        print(f“Future threat likelihood is high:
{future_threat_likelihood}. Taking preventive measures.”)
        # Simulate preventive actions
        self.adapt_firewall_rules( )
    def adapt_firewall_rules(self):
      “““Adapt firewall rules based on predicted threats.”””
      print(“Adapting firewall rules to prevent predicted future
threats.”)
      # Simulate the process of tightening security configurations
    def run_real_time_detection(self):
      “““Simulate real-time detection for a series of traffic data.”””
      self.train_model( )
      for _ in range(10): # Simulate real-time traffic over 10 iterations
        real_time_data = self.simulate_real_time_traffic( )
        self.detect_threat(real_time_data)
        time.sleep(1) # Simulate a small delay between real-time
traffic inputs
  # Instantiate the AI-based cyber security system and run real-time
detection
  cybersecurity_system = AICyberSecurityThreatDetection( )
  cybersecurity_system.run_real_time_detection( )
```

### Key Functionalities in This Code:

### Simulating Real-Time Traffic:

simulate_real_time_traffic: Generates random traffic data to simulate network traffic.

It could be replaced with actual network packet data for real-world applications.

### Machine Learning Model:

A RandomForestClassifier is trained using simulated network data, with the ability to detect whether the traffic is Normal or a Threat.

The model uses basic features like packet size and traffic duration, which can be expanded to include more complex network traffic features.

### Real-Time Threat Detection:

detect_threat: This method predicts whether incoming real-time traffic contains a threat.

If a threat is detected, the system takes defensive actions, such as adapting security settings.

### Preventing Future Threats:

The system predicts future threats using the predict_future_threats method, which analyzes current and historical data to anticipate potential vulnerabilities.

### IP Blocking:

block__ip: This method simulates blocking the IP address of the source of the detected threat.

### Adaptation and Prevention:

The system adapts its security configurations based on detected and predicted threats, preventing future attacks.

### Integration

This code can be integrated with the first code, which includes the logging, device monitoring, and incident reporting functionalities. You can call the detect_threat and predict_future_threats methods within the main system to leverage the AI-based threat detection.

### Human-AI Collaborative Threat Mitigation and Learning

In addition to automated threat identification and mitigation, the system integrates a human feedback loop designed to work alongside the AI, enabling cybersecurity professionals to review, validate, and refine threat responses. This adaptive feedback mechanism allows for continuous improvement in threat-handling efficacy through a dynamic learning process, fostering a collaborative environment where the AI and human users learn from each other.
Collaborative Threat Blocking: While the system automatically blocks detected threats by adjusting firewall rules and access permissions, it also notifies cybersecurity personnel for review. This collaborative process allows experts to evaluate and validate the AI's decisions, adjust responses as necessary, and provide feedback to refine future threat-handling accuracy.
Adaptive Human Feedback Loop: The human feedback loop enables cybersecurity teams to directly input adjustments and insights gained during threat response. This human input not only influences the immediate incident but also improves the AI's future threat detection and response capabilities. By analyzing this data, the AI system continuously updates its pattern recognition and threat mitigation protocols, enhancing both the system's intelligence and responsiveness.

Thus, there is provided according to the present invention a system for providing adaptive cybersecurity protection comprising:
An application-specific integrated circuit (ASIC) for an artificial neural network connected to a communications network, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits configured to identify one or more cybersecurity threats through pattern recognition of anomaly detection across network traffic;
A network communication device with an associated processor configured to: dynamically adjust firewall rules, access permissions, and network configurations to neutralize the identified threat; and configured to locate the origin of the identified threat by tracking the IP address and related metadata; and
A display device configured to display an incident report containing threat type, origin, potential system vulnerabilities exploited, and, optionally, preventative measure taken.

Through this dual-learning approach, the AI becomes more adept at preemptively identifying and neutralizing threats, while human operators remain fully engaged in tailoring the security environment to evolving risks. This synergy ensures robust, adaptive protection, with AI-driven automation complemented by expert human oversight, fostering a seamless learning cycle between technology and human expertise for optimal cybersecurity outcomes.

### DETAILED DESCRIPTION OF FIGURES

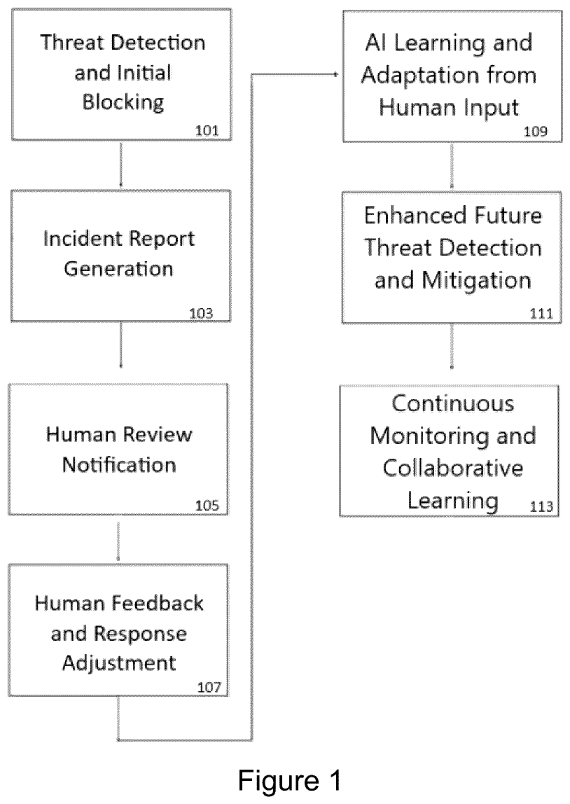

FIG. 1.101—Threat Detection and Initial Blocking—The AI system continuously monitors network traffic for anomalies. Upon detecting a potential threat, it initiates automated response actions, such as blocking IP addresses and adjusting firewall rules, to prevent network intrusion.

FIG. 1.103—Incident Report Generation—Following the initial threat response, the AI generates a real-time incident report detailing the threat type, origin, impacted systems, and automated actions taken.

FIG. 1.105—Human Review Notification—The system transmits the incident report to designated cybersecurity personnel, notifying them of the detected threat and the AI's initial response actions for expert review.

FIG. 1.107—Human Feedback and Response Adjustment—The cybersecurity team assesses the AI's automated responses, approving or adjusting actions as necessary. They can add new insights, such as emerging threat patterns, which the AI will integrate for refining future responses.

FIG. 1.109—AI Learning and Adaptation from Human Input—The AI processes human feedback, adapting its algorithms for enhanced accuracy in threat detection and mitigation. This ongoing adaptation improves the system's ability to recognize and respond to similar threats more effectively in the future.

FIG. 1.111—Enhanced Future Threat Detection and Mitigation—Equipped with updated detection patterns, the system integrates human-provided insights to proactively detect and mitigate future threats, increasing the resilience of network defenses.

FIG. 1.113—Continuous Monitoring and Collaborative Learning—The AI and human team maintain continuous monitoring of network activity, with each interaction and feedback cycle strengthening the overall cybersecurity framework through collaborative learning and adaptation.

What is claimed is:

1. A system for providing adaptive cybersecurity protection comprising:
a. An application-specific integrated circuit (ASIC) for an artificial neural network connected to a communications network, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits configured to identify one or more cybersecurity threats through pattern recognition of anomaly detection across network traffic;
b. A network communication device with an associated processor configured to: dynamically adjust firewall rules, access permissions, and network configurations to neutralize the identified threat; and configured to locate the origin of the identified threat by tracking the IP address and related metadata; and
c. A display device configured to display an incident report containing threat type, origin, potential system vulnerabilities exploited, and, optionally, preventative measure taken.

2. The system of claim 1, wherein the threat detection module utilizes deep learning algorithms to continuously monitor incoming and outgoing network traffic for abnormal behaviors indicative of potential cyber threats.

3. The system of claim 2, wherein the adaptive response mechanism automatically patches vulnerabilities identified during the cyberattack in real time to prevent the recurrence of the exploit.

4. The system of claim 3, wherein the tracing module is capable of identifying the geographic location and device type of the threat origin by analyzing IP address details, network layers, and device signatures.

5. The system of claim 4, wherein the reporting module produces incident reports in real-time and transmits the reports to designated security personnel, including step-by-step breakdowns of incident response actions taken.

6. The system of claim 1, further comprising:
a. A logging module configured to record every device connecting to the network via Wi-Fi or hardline connections.
b. A device identification system configured to profile each device based on unique identifiers, such as MAC addresses, IP addresses, and device metadata.
c. A compliance system configured to monitor and enforce security policies based on the type and identity of the devices accessing the network.

7. The system of claim 6, wherein the logging module continuously monitors hardline connections to ensure that wired network access is subject to the same level of scrutiny as wireless access.

8. The system of claim 7, wherein the device identification system profiles devices and assigns a risk score based on the device's behavior history and security posture.

9. The system of claim 8, wherein the compliance system automatically restricts or quarantines devices that do not meet predetermined security thresholds.

10. The system of claim 1, wherein the network communication device with an associated processor is configured for operations further comprising:
a. Responding to the identified threats by automatically adapting network security policies and patching vulnerabilities;
b. Tracking the origin of the threats by analyzing network traffic and identifying source IP addresses; and
c. Generating a report outlining recommendations for future threat prevention with respect to the source IP addresses.
